(19) United States
(12) Patent Application Publication
(10) Pub. No.: US 2025/0299489 A1
(43) Pub. Date: Sep. 25, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YOSHIKI OHNO, Kanagawa (JP)

(21) Appl. No.: 19/079,313

(22) Filed: Mar. 13, 2025

(30) Foreign Application Priority Data
Mar. 21, 2024 (JP) 2024-044844

(51) Int. Cl. G06V 20/52; G06T 7/11; G06V 10/44

(52) U.S. Cl. CPC G06V 20/52; G06T 7/11; G06V 10/443

(57) ABSTRACT

An information processing apparatus for detecting, from an image, an object to be tracked; estimating a local part from the image; selecting, from among one or more local parts estimated, a local part having a highest degree of association with the object to be tracked; and determining, based on the object detected and to be tracked and the local part selected from among the one or more local parts, whether to associate the object detected and to be tracked with the local part selected.

### BACKGROUND OF THE DISCLOSURE

### Field of the Disclosure

The present disclosure relates to an information processing technique for detecting an object from an image and tracking the object.

### Description of the Related Art

A specific object region is detected from images continuous in time-series order and is tracked.

Tracking is to detect a specific object region from an image and track the identical object region in images continuous in time-series order. In an image capturing apparatus (camera), autofocus processing and the like are performed based on results of the tracking.

Japanese Patent Laid-Open No. 2017-212581 discloses a method for tracking a whole object to be tracked and a local part of the object in association with each other. For example, in a case where the object to be tracked is a human figure, a whole human body is assumed to be the whole object to be tracked, and a facial part or the like is assumed to be the local part. In Japanese Patent Laid-Open No. 2017-212581, the association is performed based on a positional relationship between the whole object and the local part on an image, and amounts of change in the positions of the whole object and the local part in images continuous in time-series order.

In the association based on the positional relationship between the whole object and the local part disclosed in Japanese Patent Laid-Open No. 2017-212581, in a case that the local part of the object is not detected, an error in which a local part of an object or the like different from the object to be tracked is associated with the whole object to be tracked may occur. In addition, in a case that autofocus operates on a local part associated in an image capturing apparatus, the image capturing apparatus may focus on a head part of another human figure due to the incorrect association of the local part. In particular, in a case that an image of a sports scene where multiple human figures are crowded together is captured, and the focus is on a human figure different from a human figure to be tracked, there is a possibility that the quality of the image capturing may be significantly reduced.

### SUMMARY OF THE DISCLOSURE

Therefore, the present disclosure aims to prevent the occurrence of incorrect association in which an object to be tracked is associated with another object or the like.

An information processing apparatus according to the present disclosure includes at least one memory storing instructions; and at least one processor that, upon execution of the stored instructions, causes the information processing apparatus to function as: a detector that detects, from an image, an object to be tracked; an estimator that estimates a local part from the image; a selector that selects, from among one or more local parts estimated by the estimator, a local part having a highest degree of association with the object to be tracked; and a determiner that determines, based on the object detected by the detector and to be tracked and the local part selected by the selector from among the one or more local parts, whether to associate the object detected by the detector and to be tracked with the local part selected by the selector.

Further features of the present disclosure will become apparent from the following description of exemplary embodiments with reference to the attached drawings.

### BRIEF DESCRIPTION OF THE DRAWINGS

FIG. 1 is a schematic configuration diagram of a computer capable of implementing an information processing apparatus.

FIG. 2 is a functional configuration diagram of the information processing apparatus.

FIG. 3 is a flowchart illustrating a procedure of information processing.

FIGS. 4A to 4D are explanatory diagrams of input images without occlusion and tracking and local part estimation results.

FIGS. 5A to 5F are explanatory diagrams of input images with occlusion and tracking and local part estimation results.

### DESCRIPTION OF THE EMBODIMENTS

Hereinafter, embodiments of the present disclosure will be described with reference to the drawings. Each of the following embodiments does not limit the present disclosure, and not all of combinations of features described in the embodiments are necessarily essential to the solution of the present disclosure. Configurations described in the embodiments may be appropriately modified or changed based on specifications of apparatuses to which the present disclosure is applied and various conditions (conditions of use, usage environments, and the like).

In the following embodiments, configurations that are identical or similar to each other are denoted by the same reference signs, processing steps that are identical or similar to each other are denoted by the same reference signs, and repeated descriptions are omitted.

### First Embodiment

An information processing apparatus according to the present embodiment receives images continuous in time-series order, detects a specific object to be tracked from the continuous images, detects a local part accompanying the object to be tracked, associates the object to be tracked with the local part, and tracks the object to be tracked. The present embodiment describes an example in which the object to be tracked is a human figure and the local part is the face of the human figure, but the present embodiment is not limited thereto. For example, the object to be tracked may be the face of the human figure, and a pupil in the face may be the local part. The object to be tracked is not limited to the human figure and may be an animal. In this case, the whole object may be the whole body of the animal, and the local part may be the head (face) of the animal. In addition, the local part may be any part accompanying the object to be tracked and may not be a part of a portion of the object. For example, the object to be tracked may be a vehicle in which a human figure rides. In this case, the local part may be the human figure or the head of the human figure. The human figure or the head part of the human figure is not a portion of the vehicle, but moves along with the vehicle which is the object to be tracked. Therefore, in a case where the vehicle is the object to be tracked, the human figure riding in the vehicle or the head part of the human figure riding in the vehicle can be regarded as the local part.

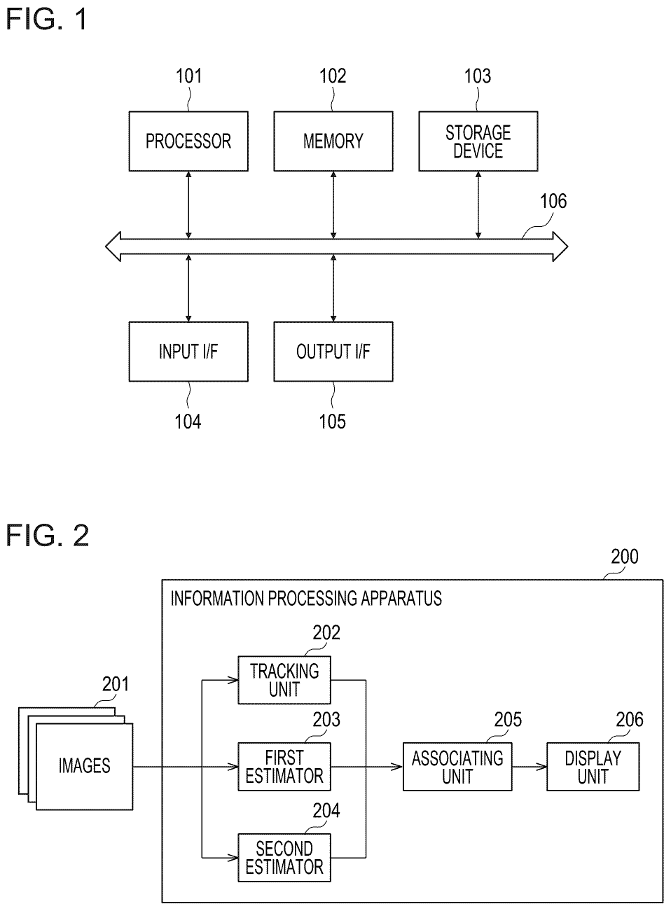

FIG. 1 is a diagram illustrating a schematic basic configuration of a computer capable of implementing the information processing apparatus according to the present

The computer includes a processor 101, a memory 102, a storage device 103, an input IF 104, an output IF 105, and a bus 106. The processor 101 is, for example, a CPU and controls the overall operation of the computer. The storage device 103 includes, for example, an HDD, an SSD, a CD-ROM, or the like as a storage medium readable by the computer, and stores various programs, data, and the like for a long period of time.

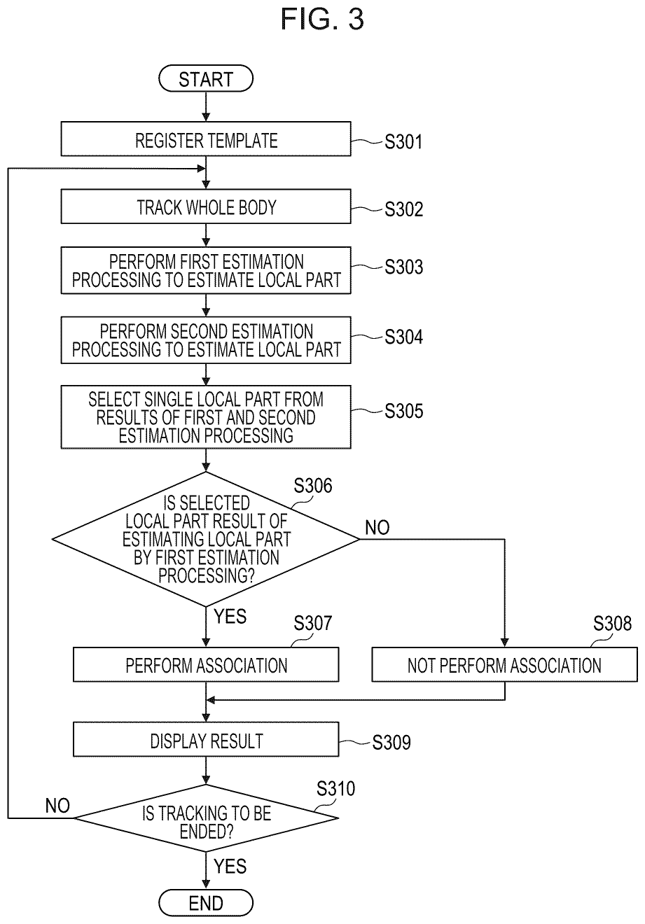

The storage device 103 stores an information processing program that implements each of functional units 202 to 206 included in the information processing apparatus 200 illustrated in FIG. 2 and a process in a flowchart illustrated in FIG. 3 by the information processing apparatus. The information processing program is read out into the memory 102. The memory 102 is, for example, a RAM and temporarily stores various programs including the information processing program according to the present embodiment, data, and the like.

The processor 101 implements each of the functional units included in the information processing apparatus (illustrated in FIG. 2) according to the present embodiment and the process in the flowchart illustrated in FIG. 3 by executing the information processing program on the memory 102.

The input IF 104 is an interface for acquiring information from an external apparatus.

The output IF 105 is an interface for outputting information to an external apparatus.

The bus 106 connects the units described above and enables the units to transmit and receive various types of data such as images to and from each other.

FIG. 2 is a functional block diagram illustrating each of the functional units implemented by the information processing apparatus 200 according to the present

Images 201 are continuous in time-series order and input to the information processing apparatus 200. For example, in a case where the information processing apparatus 200 according to the present embodiment is mounted in an image capturing apparatus (camera), the images 201 may be images forming frames of a moving image captured by the image capturing apparatus. The images continuous in time-series order may be images included in a moving image captured and stored in the storage device 103 in advance, in addition to the images captured by the image capturing apparatus.

The tracking unit 202 detects, from the images 201 continuous in time-series order, the object to be tracked, and tracks the object.

Each of the first estimator 203 and the second estimator 204 estimates, from the images 201, a region of a local part which is a candidate for association with the object to be tracked. In the present embodiment, the first estimator 203 performs first estimation processing to estimate a region of a local part which has high reliability and is a candidate for association with the object to be tracked. The second estimator 204 performs second estimation processing to estimate a region of a local part which is a candidate for association with the object to be tracked and has lower reliability than that of the region of the local part estimated in the first estimation processing. A difference between the first estimator 203 and the second estimator 204 and a specific method for implementing the first estimator 203 and the second estimator 204 will be described later in detail.

The associating unit 205 selects a single region of a local part most highly associated with a result of tracking the object to be tracked by the tracking unit 202 from a region of a local part having high reliability and estimated by the first estimator 203 and a region of a local part having low reliability and estimated by the second estimator 204. That is, the associating unit 205 selects a local part having the highest degree of association with the object to be tracked from one or more local parts estimated by the first and second estimators 203 and 204. Furthermore, the associating unit 205 determines, based on the selected local part and the object to be tracked, whether to associate the selected local part with the object to be tracked, that is, whether to perform the association. A specific method for implementing the associating unit 205 will be described later in detail. After the determination, the associating unit 205 outputs, to the display unit 206, the result of determining whether to perform the association.

The display unit 206 generates display data of an image and information and transmits the display data to a display apparatus (not illustrated) connected to the output IF 105. For example, the display unit 206 generates display data of a graphical user interface (GUI) via which a user can enter various instructions and the like from an operation apparatus (not illustrated) while viewing the display of the display apparatus, and generates display data indicating a result of information processing by the information processing apparatus 200. In the present embodiment, the display data of the GUI includes, for example, display data to be used for the user to set the object to be tracked by the tracking unit 202. The display data indicating the result of the information processing includes display data indicating local parts estimated by the first estimator 203 and the second estimator 204, and display data indicating the result of the association by the associating unit 205. The display data is transmitted to the display apparatus, and the display apparatus performs display according to the display data. Therefore, the user can enter various instructions via the GUI and check the image and the result of the information processing by the information processing apparatus 200.

FIG. 3 is a flowchart illustrating a procedure of the information processing by the information processing apparatus 200 according to the first embodiment. In the following description of the flowchart, reference sign S indicates a processing step.

First, as processing in S301, the tracking unit 202 registers a template of a subject as the object to be tracked. For example, in a case that the user selects the subject as the object to be tracked in an input image, the template is registered by a method for registering the selected subject as the template or another method. Since the present embodiment describes the example in which the whole body of the human figure is tracked as the object to be tracked, an image of the whole body of the human figure which is the object to be tracked is registered as the template. Although the present embodiment describes an example in which tracking is performed by template matching using the template registered for tracking, the present embodiment is not limited thereto. For example, tracking using a neural network may be performed. The tracking using the template matching and the tracking using the neural network are known processing, and thus a detailed description of the processing is omitted.

Next, as processing in S302, the tracking unit 202 performs processing of tracking the object to be tracked, that is, performs processing of tracking the whole body of the human figure in the example of the present embodiment. For example, the tracking unit 202 acquires an image 201 of a current single frame from a moving image continuously input in time-series order, and searches for a region similar to the template on the image 201 of the current frame. In a case that the tracking unit 202 finds a plurality of regions similar to the template, the tracking unit 202 sets the regions as tracking candidates and acquires tracking scores for the respective tracking candidates. Each of the tracking scores is a value representing reliability that the tracking candidate is the object to be tracked, that is, a value representing a degree of certainty that the tracking candidate is the object to be tracked. The greater the value is, the higher the degree of certainty (the higher the reliability) that the tracking candidate is the object to be tracked is. For example, the tracking unit 202 calculates the tracking scores based on a degree of match with the object tracked in a past image of a previous frame, an image similarity between the object tracked in the past image of the previous frame and to be tracked and the template, and the like. Then, the tracking unit 202 sets, as a tracking result, a tracking candidate having the highest tracking score among the plurality of tracking candidates. In the present embodiment, the tracking result is information represented using the position, size, and the like of a rectangular frame which is called a bounding box and surrounds the subject indicated in the tracking result on the image. The tracking unit 202 gives the tracking result to the associating unit 205.

Next, as processing in S303, the first estimator 203 performs the first estimation processing to estimate, from the input image, a region of a local part which has high reliability and is a candidate for association with the object to be tracked. In the present embodiment, the region of the local part having high reliability indicates that the region of the local part estimated is sufficiently reliable as a result of detecting the local part. That is, the first estimation processing of estimating the region of the local part having high reliability is processing that is performed for the purpose of preventing a result of incorrect estimation in which a region of another object or the like similar to the local part is incorrectly estimated as the region of the local part from being included.

The first estimator 203 estimates, from the input image, the region of the local part accompanying the object to be tracked, and acquires an estimation score for each region of the local part estimated. In this case, as a method for estimating the local part from the image, a general known method for estimating an object may be used. As the general method for estimating an object, an object estimation method using a neural network or the like is widely used, and a detailed description of the method is omitted. The method for estimating a local part by the first estimator 203 is not limited to the object estimation method using the neural network. The number of regions of local parts estimated from the input image is not limited to one and may be plural. The estimation score is a value representing reliability that the region of the local part estimated is a region of a local part accompanying the object to be tracked, that is, a value representing a degree of certainty that the region of the local part is a region of a local part accompanying the object to be tracked. The greater the value of the estimation score is, the higher the degree of certainty (the higher the reliability) that the region of the local part estimated is a region of a local part accompanying the object to be tracked is. The estimation score is a value acquired in the objection estimation method using the neural network or another method.

Next, the first estimator 203 compares the estimation score of the region of the local part estimated with a predetermined first estimation threshold, and determines, based on a result of the comparison, whether the region of the local part estimated is a region of a local part having high reliability and accompanying the object to be tracked. In the present embodiment, the first estimation threshold is set to a value high enough to acquire only a region of a local part having high reliability and a high degree of certainty that the local part is a local part accompanying the object to be tracked, and to exclude a region such as another object similar to the local part. The first estimator 203 sets, as a region of a local part having high reliability, only a region of a local part having an estimation score greater than or equal to the first estimation threshold, does not set, as a region of a local part having high reliability, a region of a local part having an estimation score less than the first estimation threshold, and excludes the region of the local part.

Then, the first estimator 203 gives, to the associating unit 205, an estimation result represented by the position, size, and the like of a rectangular frame (bounding box) surrounding the region of the local part estimated and having high reliability on the image. In this case, the first estimator 203 gives, to the estimation result, a flag or the like indicating that the region of the local part has been estimated by the first estimator 203. Therefore, the associating unit 205 can identify that the estimation result is derived from the first estimator 203.

For example, in a case where the object to be tracked is a human figure, and the local part accompanying the human figure is the head part of the human figure, the first estimator 203 estimates, from the input image, a region of the human figure's head part accompanying the human figure that is the object to be tracked, and acquires an estimation score of the region of the human figure's head part estimated. For example, in a case where the estimation score of the region estimated as the human figure's head part is low, there is a possibility that an object in the region may be an object similar to the human figure's head part, such as a ball or a tire other than the human figure's head part. That is, there is a possibility that the result of estimating the human figure's head part includes a result of incorrectly estimating an object similar to the head part of the human figure, such as a ball or a tire. Therefore, the first estimator 203 acquires only the human figure's head part having an estimation score greater than or equal to the first estimation threshold, and thus acquires, as an estimation result, only the region of the human figure's head part having high reliability while excluding another object such as a ball similar to the human figure's head part. After that, the first estimator 203 gives a flag indicating that the region of the human figure's head part has been estimated by the first estimator 203 to an estimation result represented by the position, size, and the like of the rectangular frame (bounding box) surrounding the region of the human figure's head part estimated and having high reliability on the image. Then, the first estimator 203 gives the estimation result with the flag to the associating unit 205.

Next, as processing in S304, the second estimator 204 performs second estimation processing to estimate, from the input image, a region of a local part which is a candidate for association with the object to be tracked but has reliability lower than that of the region of the local part estimated in the first estimation processing. In the present embodiment, the region of the local part estimated and having low reliability is not sufficiently reliable unlike the region of the local part having high reliability but is likely to be a local part. The second estimator 204 acquires an estimation score for each region of the local part estimated as being likely to be the local part in a similar manner to the above description, and compares the estimation score with a predetermined second estimation threshold. However, the second estimation threshold used by the second estimator 204 is a value different from the first estimation threshold used by the first estimator 203 and is set as a value less than the first estimation threshold.

The second estimator 204 compares the estimation score of the region of the local part estimated with the predetermined second estimation threshold, and determines, based on a result of the comparison, whether the region of the local part has low reliability. That is, the second estimator 204 uses the second estimation threshold less than the first estimation threshold to acquire, as a result of estimating a region likely to be the region of the local part, a region of a local part excluded by the first estimator 203 and having low reliability. In other words, the second estimation processing is performed for the purpose of estimating a region that has been excluded as not being a region of a local part having high reliability in the first estimation processing and is likely to be the local part. In the second estimation processing, a general known objection estimation method may be used in a similar manner to the above description.

Since the second estimation threshold that is less than the first estimation threshold is used in the second estimator 204, it is expected that a larger number of regions of local parts including a region of a local part estimated by the first estimator 203 than the number of regions of local parts estimated by the first estimator 203 are acquired as estimation results by the second estimator 204. Therefore, the second estimator 204 deletes a region overlapping with the region of the local part estimated by the first estimator 203 and having high reliability among the estimated regions of the local parts, and thus does not output an estimation result overlapping with the local part estimated by the first estimator 203. For example, the second estimator 204 computes Intersection over Union (IoU) between a result of estimating a region by the second estimator 204 and a result of estimating a region by the first estimator 203 and determines, based on the computed value, whether the regions overlap with each other. The IoU is, for example, a value obtained by dividing the area of an intersection of sets of the two regions by the area of a union of sets of the two regions, in other words, a value representing the ratio of the overlapping areas. Therefore, as the value of the IoU approaches 1, the two regions more overlap with each other. In a case where a value of IoU of a region of a local part estimated by the second estimator 204 is greater than or equal to a certain value, the second estimator 204 deletes a result of estimating the local part. The method for determining whether regions overlap with each other is not limited thereto, and another method may be used.

Then, the second estimator 204 gives, to the associating unit 205, an estimation result represented by the position, size, and the like of a rectangular frame (bounding box) surrounding the region of the local part estimated in the above-described manner and having low reliability on the image. In addition, the second estimator 204 gives, to the estimation result, a flag or the like indicating that the region has been estimated by the second estimator 204 in a similar manner to that described above. Therefore, the associating unit 205 can identify that the estimation result is derived from the second estimator 204.

Since a plurality of objects to be tracked may be present in a single image, each of the number of regions of local parts estimated from the single image and having high reliability and the number of regions of local parts estimated from the single image and having low reliability may be plural. On the other hand, in a case where a plurality of objects to be tracked are present in a single image, and all estimation scores of regions of local parts estimated are less than the first estimation threshold, no result of estimating a local part having high reliability may be obtained. Similarly, in a case where all estimation scores of regions of local parts estimated are less than the second estimation threshold, no result of estimating a local part having low reliability may be obtained.

Next, as processing in S305, the associating unit 205 selects a single region of a local part most highly associated with the result of tracking the object to be tracked from among the local parts that have been estimated by the first estimator 203 and the second estimator 204 and are candidates for association with the object to be tracked. For the selection processing, the associating unit 205 performs association degree determination processing to determine an association score indicating a degree of association (reliability for association) with the object to be tracked for each of the region of the local part having high reliability and the region of the local part having low reliability. After that, the associating unit 205 selects, based on the association scores, the single region of the local part most highly associated with the result of tracking the object to be tracked.

For example, in a case where a past local part associated with a tracking result of a past image of a previous frame is present, the associating unit 205 sets, for each region of a local part estimated in a current frame, an association score that becomes greater as a distance between the local part estimated in the current frame and the past local part associated with the tracking result in the previous frame becomes shorter. That is, the associating unit 205 determines a degree of association of the local part based on a distance between the past local part associated with the object to be tracked in the past image of the previous frame captured temporarily earlier than the current frame and the local part in the image of the current frame. For example, the associating unit 205 determines a degree of association of each estimated local part such that a degree of association of a first local part having a first distance from the past local part is higher than a degree of association of a second local part having a second distance from the past local part that is longer than the first distance.

In addition, for example, in a case where a past local part associated with the tracking result in the previous frame is not present, the associating unit 205 sets, for each region of a local part estimated in the current frame, an association score that becomes greater as a distance between the local part estimated in the current frame and the tracking result becomes shorter. That is, the associating unit 205 determines degrees of association such that a degree of association of a first local part having a first distance from the object to be tracked is higher than a degree of association of a second local part having a second distance from the object to be tracked that is longer than the first distance in an image.

The associating unit 205 selects, as the region of the local part most highly associated with the object to be tracked, a single region of a local part having the highest association score among the local parts estimated by the first estimator 203 and the second estimator 204 as candidates for association.

The method for calculating the association scores is not limited to the above-described method. For example, a method using a detector that estimates a line region connecting joint points of a human body may be used as disclosed in Japanese Patent Laid-Open No. 2021-86322.

Next, as processing in S306, the associating unit 205 determines whether the region of the local part selected in S305 is the region of the local part estimated by the first estimator 203 or the region of the local part estimated by the second estimator 204. Then, the associating unit 205 causes the process to proceed to S307 in a case that the associating unit 205 determines that the region of the local part selected in S305 is the region of the local part estimated by the first estimator 203. On the other hand, the associating unit 205 causes the process to proceed to S308 in a case that the associating unit 205 determines that the region of the local part selected in S305 is the region of the local part estimated by the second estimator 204.

In a case that the process proceeds to processing in S307, the associating unit 205 performs processing of associating, with the object to be tracked, the single region of the local part selected in S305, that is, the region of the local part estimated by the first estimator 203 and having high reliability.

On the other hand, in a case that the process proceeds to processing in S308, the associating unit 205 does not perform processing of associating the single region of the local part selected in S305 with the object to be tracked.

That is, the associating unit 205 does not perform the processing of associating the single region with the object to be tracked in a case that the region of the local part estimated by the second estimator 204 and having low reliability is selected in S305.

After the processing in S307 or S308, the process proceeds to S309 and the display unit 206 causes the display apparatus to display a result of the association by the associating unit 205. In this case, for example, the display unit 206 displays, in different colors on the input image, a rectangular frame representing the result of tracking the object to be tracked and a rectangular frame representing the local part associated with the object to be tracked. In a case where a region of a local part associated by the associating unit 205 is not present, the display unit 206 does not display a rectangular frame representing a local part. In addition, for example, in a case that the associating unit 205 determines not to perform the association in S306 even though a candidate for association is selected in S305, the display unit 206 may display the rectangular frame corresponding to the region of the local part in a different color from a color of the rectangular frame displayed in a case where the region of the local part associated with the object to be tracked is present.

Thereafter, as processing in S310, the information processing apparatus 200 determines whether to end the tracking. In a case that the information processing apparatus 200 determines to continue the tracking without ending the tracking, the information processing apparatus 200 returns the process to S302. On the other hand, in a case that the information processing apparatus 200 determines to end the tracking, the information processing apparatus 200 ends the process in the flowchart illustrated in FIG. 3. For example, the information processing apparatus 200 may determine, based on a predetermined condition, whether to end or continue the tracking. For example, in a case that the tracking according to the present embodiment is applied to an autofocus function of the image capturing apparatus (camera) or in a similar case, the information processing apparatus 200 may determine whether to start or end the tracking based on an operation such as a user operation of pressing a shutter button halfway or a user operation without pressing the shutter button halfway.

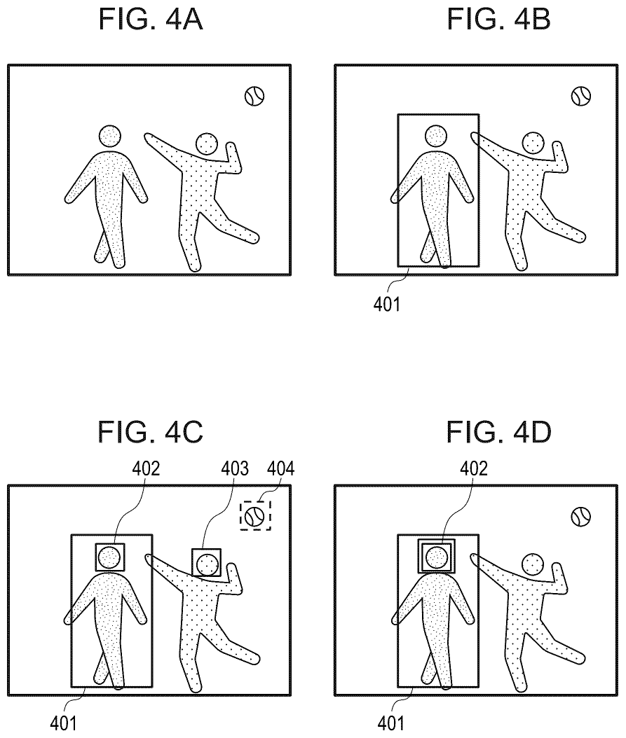

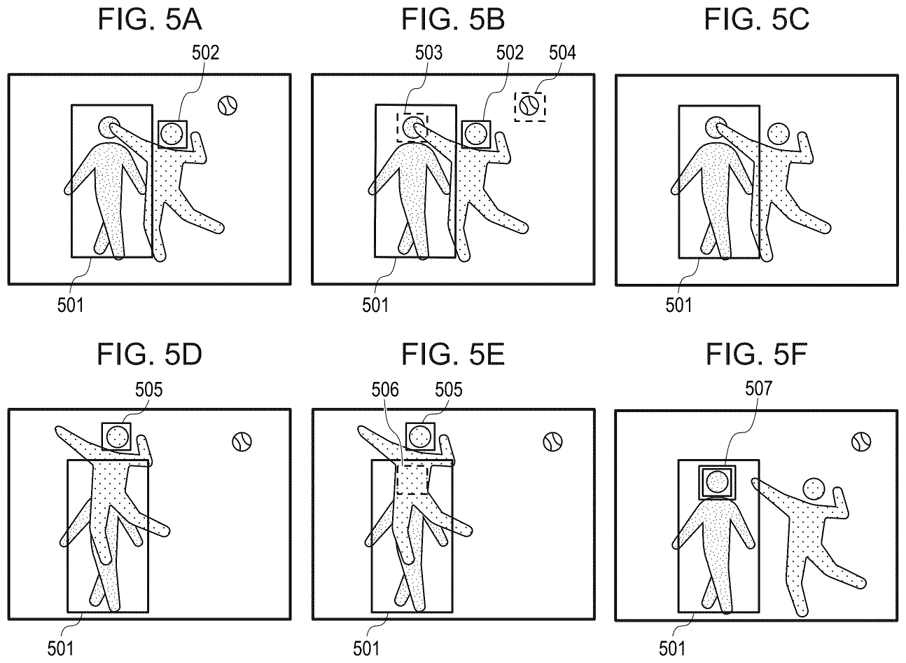

The processing from S301 to S310 in the flowchart described above will be described in more detail with reference to exemplary images illustrated in FIGS. 4A to 4D and 5A to 5F. FIGS. 4A to 4D and 5A to 5F illustrate examples in which the object to be tracked is a human figure and the local part associated with the human figure is the head part of the human figure.

For example, the image illustrated in FIG. 4A is input to the tracking unit 202 as an image of the first frame. In this case, for example, when the user selects the human figure on the left side in the image illustrated in FIG. 4A, the tracking unit 202 registers the human figure on the left side as the template in S301. Therefore, in S302, the tracking unit 202 performs whole tracking to track the whole human figure corresponding to the registered template. The image illustrated in FIG. 4B indicates an example in which a rectangular frame surrounding the human figure is set as a tracking result 401 of the whole tracking performed by the tracking unit 202 in S302.

In S303, the first estimator 203 estimates a local part that has high reliability and is a candidate for association with the human figure that is the object to be tracked. In S304, the second estimator 204 estimates a region of a local part that has low reliability and is a candidate for association. The image illustrated in FIG. 4C indicates an example in which rectangular frames representing estimation results 402, 403, and 404 indicating local parts estimated by the first estimator 203 and the second estimator 204 are set in addition to the tracking result 401 illustrated in FIG. 4B. In the estimation of the local parts, another object similar to the human figure's head part that is the local part may be estimated as the local part. In the image illustrated in FIG. 4C, the estimation result 404 indicates a rectangular frame set by estimating a ball similar to the human figure's head part as a candidate for the region of the local part.

Next, in S305, the associating unit 205 selects a single region of a local part most highly associated with the tracking result 401 of the tracking unit 202 from among candidates for all the regions of the local parts estimated by the first and second estimators 203 and 204. As described above, the associating unit 205 selects a single region of a local part based on an association score acquired for each of regions of the local parts estimated from the current frame. The image illustrated in FIG. 4C is the image of the first frame, and a past local part included in a past image of the previous frame and associated with the tracking result is not present. An estimation result that is the most proximate to the tracking result 401 among the estimation results 402 to 404 obtained from the image illustrated in FIG. 4C is the estimation result 402. Therefore, the association score for the local part indicated in the estimation result 402 is the highest value, and thus the associating unit 205 selects the region of the local part indicated in the estimation result 402 as the single region of the local part most highly associated with the human figure indicated in the tracking result 401.

Next, in S306, the associating unit 205 determines whether to finally associate the region of the local part indicated in the estimation result 402 selected in S305 with the human figure indicated in the tracking result 401. That is, in a case where the region of the local part selected in S305 is the region of the local part estimated by the first estimator 203, the associating unit 205 determines to associate the region of the local part indicated in the estimation result 402 with the tracking result. It is assumed that, in the exemplary image illustrated in FIG. 4C, the region of the local part indicated in the estimation result 402 is estimated by the first estimator 203 and has high reliability. Therefore, in this case, the associating unit 205 determines to associate the region of the local part indicated in the estimation result 402 with the tracking result.

The image illustrated in FIG. 4D indicates an exemplary image displayed by the display unit 206 in S307 after the associating unit 205 determines to associate the region of the local part indicated in the estimation result 402 with the tracking result and performs the association in S307. In the image illustrated in FIG. 4D, the estimation result 402 indicating the region of the local part associated with the human figure indicated in the tracking result 401 is displayed.

The example described with reference to FIGS. 4A to 4D indicates a case where the subject indicated in the tracking result is not occluded by another object or the like. In this case, the region of the correct local part can be associated with the tracking result 401.

Thereafter, the information processing apparatus 200 determines whether to end the tracking in S310. In this case, it is assumed that since an image of the next frame is input, the process proceeds to the processing in S302 without ending the tracking.

It is assumed that the image illustrated in FIG. 5A is the input image of the next frame. In this case, in the information processing apparatus 200, the processing in S302 and the subsequent steps is performed on the image of the next frame as illustrated in FIG. 5A. In a case that the image of the next frame is input, the tracking unit 202 performs tracking in S302 by using the template registered in S301. It is assumed that a tracking result is obtained for the image illustrated in FIG. 5A.

The first estimator 203 performs the first estimation processing on the input image in S303 in a similar manner to that described above. For example, it is assumed that the first estimator 203 estimates, from the image illustrated in FIG. 5A, a region of a local part indicated in an estimation result 502. That is, it is assumed that the head part of a human figure indicated in the estimation result 502 is different from the head part of the human figure indicated in the tracking result 501 in the exemplary image illustrated in FIG. 5A and that the first estimator 203 is unable to estimate the head part of the human figure indicated in the tracking result 501. The reason why the first estimator 203 is unable to estimate the head part of the human figure indicated in the tracking result 501 as the local part is that a portion of the head part of the human figure indicated in the tracking result 501 is hidden by a hand of the other human figure and thus an estimation score is reduced by the hiding and falls below the first estimation threshold.

If the next processing in S304 is skipped and the process proceeds to the processing in S305, the local part indicated in the estimation result 502 is associated with the tracking result 501 and the association is incorrect. On the other hand, in the present embodiment, it is possible to prevent the association from being incorrectly performed since the processing in S304 is performed. The reason will be described below with reference to the image illustrated in FIG. 5B.

In S304, the second estimator 204 performs the second estimation processing to estimate a region of a local part having low reliability. It is assumed that, in the exemplary image illustrated in FIG. 5B, results 503 and 504 of estimating the head part of the human figure are obtained by the second estimator 204. In the second estimator 204, the second estimation threshold that is less than the first estimation threshold used by the first estimator 203 is used as a threshold for comparison with an estimation score acquired by the second estimation processing. Therefore, the second estimator 204 obtains the result 503 of estimating the head part of the human figure indicated in the tracking result 501, while the first estimator 203 was unable to estimate the head part of the human figure indicated in the tracking result 501. In the exemplary image illustrated in FIG. 5B, the result 504 of incorrectly estimating that a ball is the head part of the human figure is obtained. A supplementary explanation of the incorrect estimation will be described later.

In a case that the process proceeds to the next processing in S305, the associating unit 205 selects a single local part most highly associated with the tracking result 501 from among the local parts indicated in all the estimation results 502, 503, and 504 obtained in the estimation by the first estimator 203 and the second estimator 204. In the processing performed on the past image of the previous frame described above with reference to FIGS. 4A to 4D, the association of the tracking result with the local part is performed as described above. Therefore, in S305, the associating unit 205 acquires, for each region of a local part estimated in the current frame, an association score that becomes greater as a distance between the local part estimated in the current frame and the past local part included in the previous frame and associated with the tracking result becomes shorter.

Then, the associating unit 205 selects, as a region of a local part most highly associated with the object to be tracked, a single region of a local part having the highest association score among the local parts indicated in all the estimation results 502 to 504 obtained in the estimation by the first estimator 203 and the second estimator 204. That is, the associating unit 205 selects a region of a local part that is in the image illustrated in FIG. 5B and corresponds to the estimation result 503 which is the most proximate to the estimation result 402 associated with the human figure indicated in the tracking result 401 in the image of the previous frame illustrated in FIG. 4D among the estimation results 502 to 504.

In the next processing in S306, the associating unit 205 determines whether to finally associate the local part indicated in the estimation result 503 selected in S305 with the human figure indicated in the tracking result 501. The local part indicated in the estimation result 503 is not the local part having high reliability and estimated by the first estimator 203 in S303 and is the local part having low reliability and estimated by the second estimator 204 in S304. Therefore, the associating unit 205 determines not to associate the local part indicated in the estimation result 503 selected in S305 with the human figure indicated in the tracking result 501. That is, in this case, a result of the association by the associating unit 205 indicates that a local part to be associated with the human figure indicated in the tracking result 501 is not present.

The image illustrated in FIG. 5C indicates an exemplary image displayed by the display unit 206 in S307 since an association result indicating that a local part to be associated with the human figure indicated in the tracking result 501 is not present is obtained by the associating unit 205. In the image illustrated in FIG. 5C, since a region of a local part associated with the result 501 of tracking the object to be tracked is not present, a rectangular frame indicating an estimated local part is not displayed and only a rectangular frame representing the human figure indicated in the tracking result 501 is displayed.

In S304, not only the head part of the human figure but also the result 504 of estimating the object other than the human figure's head part, such as a ball, may be obtained, as in the exemplary image illustrated in FIG. 5B. In this case, as long as the estimation result 504 is not proximate to the tracking result 501, the estimation result 504 is not selected as a local part to be associated in S305. Even if the estimation result 504 is selected as a local part to be associated in S305, the associating unit 205 determines not to perform the association in the next processing in S306, and the estimation result 504 is not displayed in S309.

As described above, since the processing in S304 is performed, in a case where the head part of the human figure indicated in the tracking result is occluded, it is possible to prevent association with an incorrect local part from being performed. Thereafter, in S310, the information processing apparatus 200 determines whether to end the tracking in a similar manner to that described above. In this case, it is assumed that an image of the next frame is not present and that the tracking is ended.

As described above, in the first embodiment, it is possible to prevent association of an incorrect local part with the result of tracking the object to be tracked. In addition, according to the present embodiment, a result of association with another object likely to be incorrectly associated can be treated as not being present. For example, in a case that the present embodiment is applied to an image capturing apparatus such as a camera, autofocus processing can be performed only on a local part correctly associated. In addition, for example, the information processing apparatus may include a controller that, in a case that the associating unit determines not to associate the object to be tracked with the selected local part, controls focus of the image capturing apparatus which focuses on the local part such that the image capturing apparatus temporarily stops autofocus processing and maintains focus on a local part in a past image, and thus it is possible to prevent the operation of the autofocus on an incorrect subject.

### Second Embodiment

In the first embodiment, since the second estimation threshold that is less than the first estimation threshold is set in the second estimator 204, the second estimator 204 estimates a region of a local part having low reliability. Therefore, the second estimator 204 is capable of estimating the head part of the human figure indicated in the tracking result having a low estimation score since a portion of the head part is occluded or the like as in the exemplary image illustrated in FIG. 5B. However, in an actual use case, for example, the whole head part of the human figure indicated in the tracking result may be occluded as in the exemplary image illustrated in FIG. 5D. In this case, it is not possible to estimate the head part of the human figure indicated in the tracking result even in a case that the low second estimation threshold is used.

In the second embodiment, the first estimator 203 estimates a local part by performing, on an image of a current frame, similar analysis processing to that in the first embodiment described above. Meanwhile, the second estimator 204 estimates a local part in the image of the current frame based on a result of estimating a local part in a past image of a previous frame captured earlier than the current frame. That is, the second embodiment describes an example in which the second estimator 204 uses a result of performing estimation processing on the previous frame as second estimation processing on the image of the current frame, and thus can handle such a case as in the exemplary image illustrated in FIG. 5D. An information processing apparatus according to the second embodiment has a hardware configuration that is identical or similar to that illustrated in FIG. 1 and a functional configuration that is identical or similar to that illustrated in FIG. 2, a flowchart of information processing according to the second embodiment is substantially identical or similar to the flowchart illustrated in FIG. 3, and illustrations thereof are omitted. Differences from the information processing apparatus according to the first embodiment will be mainly described below.

The flowchart illustrated in FIG. 3 according to the second embodiment is different in processing in S304 from that in the first embodiment. In the second embodiment, in S304, in a case where a past local part associated with the tracking result is present in the previous frame, the second estimator 204 predicts the position of the local part in the current frame from the position of the past local part in the previous frame. Then, the second estimator 204 acquires an estimation result indicating that the predicted position of the local part is the position of a region of the local part acquired by the second estimation processing. For example, in a case where the images 201 input to the information processing apparatus 200 are continuous images having a high frame rate, the predicted position of the local part in the current frame may be simply set to a position identical to the position of the past local part estimated in the previous frame. Meanwhile, in a case where the input images 201 are continuous images having a low frame rate, for example, a Bayesian filter such as a Kalman filter or a particle filter may be used to estimate the position of the local part in the current frame from positional data of the past local part estimated in the previous frame. In the following description, an example in which only a past local part included in the previous frame and associated with the tracking result is estimated is described, but estimation that is identical or similar to that described above may be performed on all past local parts estimated in the previous frame.

The processing according to the second embodiment will be described below with reference to the exemplary images illustrated in FIGS. 5D to 5F. In the second embodiment, processing that is identical or similar to that described in the first embodiment is performed on an image of the first frame, and a description of the processing is omitted. The images illustrated in FIGS. 5D and 5E are, for example, images of the second frame, and indicate an example in which the whole head part of the human figure that is the object to be tracked is occluded. In addition, it is assumed that the image illustrated in FIG. 5F is a past image of a frame previous to the current frame illustrated in FIGS. 5D and 5E.

In the exemplary image illustrated in FIG. 5D, the head part of the human figure that is the object to be tracked is occluded by a body of another human figure, and thus only a result 505 of estimating the head part of the other human figure is obtained in the first estimation processing in S303. The human figure indicated in the estimation result 505 is different from the human figure indicated in the tracking result 501. If the estimation result 505 is associated with the tracking result 501, the association is incorrect.

As illustrated in the image in FIG. 5F, it is assumed that the human figure's head part indicated in an estimation result 507 is associated with the tracking result 501 in the previous frame by the association in S307. That is, it is assumed that, in the previous frame, the human figures do not intersect with each other and the local part is correctly associated with the tracking result 501 as indicated in the estimation result 507. In this case, in S304, the second estimator 204 generates, as a result of estimating the local part, an estimation result 506 corresponding to the position of the head part of the human figure indicated in the tracking result 501 based on the position of the estimation result 507 in the previous frame, as illustrated in the image in FIG. 5E.

Next, in S305, the associating unit 205 selects an estimation result most highly associated with the tracking result 501. In the exemplary image illustrated in FIG. 5E, the estimation result 506 is selected.

Then, in S306, the associating unit 205 performs processing of determining whether the estimation result 506 selected in S305 has been obtained by the first estimation processing or the second estimation processing. In the exemplary image illustrated in FIG. 5E, the estimation result 506 indicates the region of the local part estimated by the second estimator 204, and the associating unit 205 determines not to associate the estimation result 506 with the tracking result 501.

This prevents incorrect association of the estimation result 505 indicating the head part of the human figure different from the human figure indicated in the tracking result 501. The subsequent processing is identical or similar to that in the first embodiment, and a description of the processing is omitted.

As described above, according to the second embodiment, even in a case where the whole local part of the object to be tracked is occluded, it is possible to prevent incorrect association of a local part with the object to be tracked.

### Third Embodiment

In the second embodiment, incorrect association in a state in which the whole local part of the object to be tracked is occluded is prevented by using the result of the association in the previous frame. However, for example, in a case where the image illustrated in FIG. 5D is the image of the first frame, it is not possible to use the result of the association in the previous frame. This is not limited to the first frame, and the same applies to a case where association is not performed in frames previous to the second and subsequent frames.

Therefore, the second estimator 204 according to the third embodiment estimates the position of a local part by performing occlusion detection processing to estimate the position of the local part occluded by an occluding object in an input image even in a case where it is not possible to use a result of association in a previous frame. In a case that the associating unit 205 selects, as a candidate for a local part to be associated with the object to be tracked, the local part estimated in the occlusion detection processing by the second estimator 204, the associating unit 205 determines not to associate the selected local part with the object to be tracked. An information processing apparatus according to the third embodiment has a hardware configuration that is identical or similar to the hardware configuration illustrated in FIG. 1, and a functional configuration that is identical or similar to the functional configuration illustrated in FIG. 2, a flowchart of information processing according to the third embodiment is substantially identical or similar to the flowchart illustrated in FIG. 3, and illustrations thereof are omitted. Differences from the information processing apparatuses according to the first and second embodiments will be mainly described below.

The flowchart illustrated in FIG. 3 according to the third embodiment is different in processing in S304 from those in the first and second embodiments. In the third embodiment, in S304, the second estimator 204 performs occlusion detection processing to estimate the position of a local part occluded by another human figure, another object, or the like.

In the third embodiment, the occlusion detection processing is performed by the second estimator 204 using, for example, an inference unit trained to be capable of reliably detecting a local part occluded by an occluding object or the like. The inference unit is trained to directly detect a region of an occluded local part from an actually captured image in which the local part is actually occluded as in such an image as illustrated in FIG. 5D or a synthesis image obtained by synthesizing an occluding object with an actually captured image in which the local part is not occluded. Alternatively, the inference unit may be trained to detect a line region connecting joint points of a human body and may estimate the position of a head part (local part) from a result of detecting the line region connecting the joint points of the human body, as in the technique disclosed in Japanese Patent Laid-Open No. 2021-86322.

The third embodiment will be described using the exemplary images illustrated in FIGS. 5D and 5E.

It is assumed that the image illustrated in FIG. 5D is input as an input image of the first frame to the second estimator 204. Processing up to S303 is identical or similar to that in the second embodiment described above and a description of the processing is omitted. In the third embodiment, it is assumed that the tracking result 501 is obtained by the whole tracking in S302 and that the estimation result 505 is obtained by the first estimation processing in S303.

In the image illustrated in FIG. 5D, since the head part of the human figure indicated in the tracking result 501 is occluded by the body of the other human figure, only the estimation result 505 indicating the head part of the other human figure is obtained in S303. If the local part is associated with the tracking result 501, the estimation result 505 indicating the head part of the other human figure is associated, and the association is incorrect. Therefore, in S304, the second estimator 204 performs occlusion detection processing on the local part in the region of the rectangular frame of the tracking result 501 by using the above-described inference unit for the occlusion detection processing and estimates the position of the local part based on the result of the occlusion detection processing. Therefore, the second estimator 204 can obtain the result 506 of estimating the local part as illustrated in the image in FIG. 5E. The subsequent processing is identical or similar to that in the second embodiment and a description of the processing is omitted.

As described above, according to the third embodiment, even in a case where the whole local part of the object to be tracked is occluded and it is not possible to use a result of association in a previous frame, it is possible to prevent association of an incorrect local part with the object to be tracked.

The present disclosure can also be implemented by processing of supplying a program for implementing one or more of the functions described in the embodiments to a system or an apparatus via a network or a storage medium and reading and executing the program by one or more processors in a computer in the system or the apparatus. In addition, the present disclosure can also be implemented by a circuit (for example, an ASIC) that implements one or more of the functions described in the embodiments. The above-described embodiments are merely examples of implementation of the present disclosure, and the technical scope of the present disclosure should not be construed in a limited manner. That is, the present disclosure can be implemented in various forms without departing from the technical idea or the main features of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-044844, filed Mar. 21, 2024, which is hereby incorporated by reference herein in its entirety.

What is claimed is:

1. An information processing apparatus comprising:
at least one memory storing instructions; and
at least one processor that, upon execution of the stored instructions, causes the information processing apparatus to function as:
a detector that detects, from an image, an object to be tracked;
an estimator that estimates a local part from the image;
a selector that selects, from among one or more local parts estimated by the estimator, a local part having a highest degree of association with the object to be tracked; and
a determiner that determines, based on the object detected by the detector and to be tracked and the local part selected by the selector from among the one or more local parts, whether to associate the object detected by the detector and to be tracked with the local part selected by the selector.

2. The information processing apparatus according to claim 1, wherein
the determiner
determines to associate the local part with the object to be tracked in a case that reliability of the local part selected by the selector is greater than or equal to a threshold, and
determines not to associate the local part with the object to be tracked in a case that the reliability of the local part selected by the selector is less than the threshold.

3. The information processing apparatus according to claim 1, wherein
the estimator includes
a first estimator that estimates the local part from the image, and
a second estimator that estimates, from the image, a local part having reliability lower than reliability of the local part estimated by the first estimator,
the selector selects a local part having a highest degree of association with the object to be tracked from among the one or more local parts estimated by the first estimator and the second estimator, and
the determiner
determines to associate the local part selected by the selector with the object to be tracked in a case that the selected local part is the local part estimated by the first estimator, and
determines not to associate the local part selected by the selector with the object to be tracked in a case that the selected local part is the local part estimated by the second estimator.

4. The information processing apparatus according to claim 2, wherein the reliability is a degree of certainty of the local part estimated by the estimator.

5. The information processing apparatus according to claim 1, wherein in a case that the determiner determines not to associate the local part selected by the selector with the object to be tracked, any local part is not associated with the object to be tracked in the image.

6. The information processing apparatus according to claim 1, further comprising:
an association degree determiner that determines, based on a distance between a local part in the image and a past local part that is included in a past image captured temporarily earlier than the image and is associated with the object to be tracked, a degree of association of the local part, wherein
the association degree determiner determines a degree of association of each of the one or more local parts such that a degree of association of a first local part having a first distance from the past local part is higher than a degree of association of a second local part having a second distance from the past local part, the second distance being longer than the first distance.

7. The information processing apparatus according to claim 1, further comprising:
an association degree determiner that determines a degree of association of each of the one or more local parts based on a distance between the object to be tracked and the one or more local parts in the image such that a degree of association of a first local part having a first distance from the object to be tracked among the one or more local parts is higher than a degree of association of a second local part having a second distance from the object to be tracked among the one or more local parts, the second distance being longer than the first distance.

8. The information processing apparatus according to claim 1, wherein
the estimator includes
a first estimator that estimates a local part by performing analysis processing on the image, and
a second estimator that estimates a local part in the image based on a result of estimating a local part in a past image captured earlier than the image, and
in a case that the local part estimated by the second estimator is selected by the selector, the determiner determines not to associate the object to be tracked with the selected local part.

9. The information processing apparatus according to claim 1, wherein
the estimator includes an occlusion detector that estimates a position of a local part occluded by an occluding object in the image, and
in a case that the local part estimated by the occlusion detector is selected by the selector, the determiner determines not to associate the object to be tracked with the selected local part.

10. The information processing apparatus according to claim 1, further comprising:
a display unit that displays a result of the association of the object to be tracked with the selected local part.

11. The information processing apparatus according to claim 1, further comprising:
a controller that, in a case that the determiner determines not to associate the object to be tracked with the selected local part, controls focus of an image capturing unit which focuses on the local part such that the image capturing unit temporarily stops autofocus processing and maintains focus on a local part in a past image.

12. An information processing method comprising:
detecting, from an image, an object to be tracked;
estimating a local part from the image;
selecting a local part having a highest degree of association with the object to be tracked from among one or more local parts estimated in the estimating; and
determining, based on the object detected by the detecting and to be tracked and the local part selected by the selecting from among the one or more local parts, whether to associate the object detected by the detecting and to be tracked with the local part selected by the selecting.

13. A non-transitory computer-readable storage medium storing a program for causing a computer to execute a method comprising:
detecting, from an image, object to be tracked;
estimating a local part from the image;
selecting a local part having a highest degree of association with the object to be tracked from among one or more local parts estimated in the estimating; and
determining, based on the object detected by the detecting and to be tracked and the local part selected by the selecting from among the one or more local parts, whether to associate the object detected by the detecting and to be tracked with the local part selected by the selecting.
